(19) United States
(12) Patent Application Publication
(10) Pub. No.: US 2013/0167871 A1
(43) Pub. Date: Jul. 4, 2013

(54) Car Wash Air Dryer Blower Flow Restrictor Arrangement And Method

(71) Applicant: Mark T. Jones, Troy, MI (US)

(72) Inventor: Mark T. Jones, Troy, MI (US)

(73) Assignee: PECO CORPORATION, Auburn Hills, MI (US)

(21) Appl. No.: 13/566,158

(22) Filed: Aug. 3, 2012

Related U.S. Application Data
(60) Provisional application No. 61/526,788, filed on Aug. 24, 2011.

(51) Int. Cl. B60S 3/00

(52) U.S. Cl. CPC B60S 3/002
USPC 134/18; 134/115 R

(57) ABSTRACT

Stacked inner and outer discs are mounted over an air blower inlet opening of each blower in a car wash system drying zone with matched sets of radial slots and spokes formed in each disc. An actuator rotates one disc between positions in which the set of slots in one disc is aligned with the set of slots in the other disc to allow air flow into the blower inlet to dry a car in the dryer zone to a position in which the set of spokes overlie the set of slots in the other disc to thereby block inlet air flow to reduce the load on a blower motor when a car is not in the dryer zone.

### CROSS REFERENCE TO RELATED PATENT APPLICATIONS

This application claims the benefit of U.S. provisional application No. 61/526,788 filed on Aug. 24, 2011.

### BACKGROUND OF THE INVENTION

This invention concerns car wash systems and more particularly blowers for the drying zone of such systems.

In a car wash system, an array of high volume air blowers is typically mounted on a framework within which a car which has been washed is transported on a conveyor with nozzles directing air jets of the car so as to blow off the rinse water and dry the surfaces of the car.

The high volume air blowers are quite noisy when operating and consume considerable electric power when running at full capacity so that various arrangements have been devised to reduce the airflow output of the blowers when cars are not present in the drying zone.

These arrangements have included pivoted damper plates which are installed at the blower inlet (or the outlet) of the blower. Such an arrangement is bulky and complicated particularly since it must accommodate a safety mesh which usually also installed over the inlet to prevent objects from entering the blower plenum a person from reaching into the blower interior which could result in an injury. The damper must be rotated 90° to be opened or closed against the fluid pressure force created by the airflow.

Also, the air flow may be restricted to some extent by the pressure of the damper plates even when they are in an opened condition.

Another approach involves mounting a sliding gate which may be moved to cover the inlet, but this arrangement likewise is complex and bulky requiring space for the gate to one side. Furthermore, significant range of movement of the sliding gate to open and close the inlet opening, against large frictional resistance.

Pivoted side plates have also been used in other applications as well as other arrangements which suffer from some of the same disadvantages.

A shutter mechanism has also been employed in which a plurality of shutters is pivoted from a blocking to an open position.

This arrangement is also complicated and noisy and may appreciably restrict the flow when opened, and also would potentially interfere with a safety grate when opened if the safety grate was installed over the shutter.

Use of an electrical motor controller to start and stop the blower motor is not practical due to very large start up electrical current draws, greatly increasing the power consumption of the powerful motors required.

Accordingly, it is an object of the present invention to provide an air flow restrictor arrangement in combination with such car wash blowers for controllably reducing the volume of air flow into car wash dryer blowers to reduce power consumption and noise when a care is not present, which is simple and compact and does not substantially impede the intake air flow when maximum flow is desired.

### SUMMARY OF THE INVENTION

The above object and other objects which will be understood upon a reading of the following specification and claims are achieved by an arrangement in which a pair of slotted discs are mounted stacked together opening.

The discs each have a matching series of radially extending slots. The slots are tapered to be of a maximum width at their outer ends and narrowest at their inner ends at a point close to the center of the discs where a center connector portion is located securing the inner ends of solid radially extending spokes which are of substantially the same size and shape, and located between adjacent slots defined in the discs. An inner disc closest an inlet flow guide is fixedly attached to the inlet flow guide aligned with an inlet opening in the blower housing. An outer disc is mounted atop and aligned with the inner disc so as to be rotatable but only to a minimal extent by fixed fasteners each passing through a respective circumferentially extending short slot at the outer perimeter of the outer disc.

A short stroke power cylinder is connected to allow the outer disc to be rotated between an open position with the radial slots of two discs aligned, allowing air to be freely drawn into the blower inlet and a closed position whereat the solid spokes of the outer disc overlie and cover the slots in the inner disc so as to block airflow into the blower inlet.

In the closed position, the load on the blower motor is greatly reduced by preventing air from being drawn into the impeller to minimize power consumption and noise in a standby state, while allowing maximum air intake in the open position. The restriction of air flow in the open condition by the presence of the slotted discs has been found to be minimal.

Since only a relatively slight rotation of the outer disc is required to pen or close the flow restrictor this can be achieved quickly and with minimal force. The two stacked discs are compact and do not require any external clearance.

The discs are preferably both constructed of a high strength plastic such as PVC, which has been determined to perform better in service than a metal inner disc due to minimal friction. The discs are drawn into tight contact by the lower pressure developed in the housing interior and thus minimizing friction therebetween is desirable.

Small solid bridging areas may be included between the slots to strengthen the discs.

### DESCRIPTION OF THE DRAWINGS

FIG. 1 is a pictorial view of a dryer zone of a car wash system depicting an array of overhead dryer blowers.

FIG. 2 is a pictorial view from the inlet side of a dryer air blower equipped with a controllable inlet air flow restrictor according to the present invention.

FIG. 3 is a side view of the air blower shown in FIG. 2 showing the drive motor.

FIG. 4 is an enlarged pictorial view of a blower inlet housing fitting having controllable flow restrictor according to the invention shown installed thereon in the open condition with the retracted position of a power cylinder shown in broken lines.

FIG. 5 is a front view of the flow restrictor arrangement shown in FIG. 4.

FIG. 5A is a front view of the flow restrictor shown in FIG. 5 but in the closed position.

FIG. 6 is a view of a section taken through the inlet flow guide flow restrictor disc.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

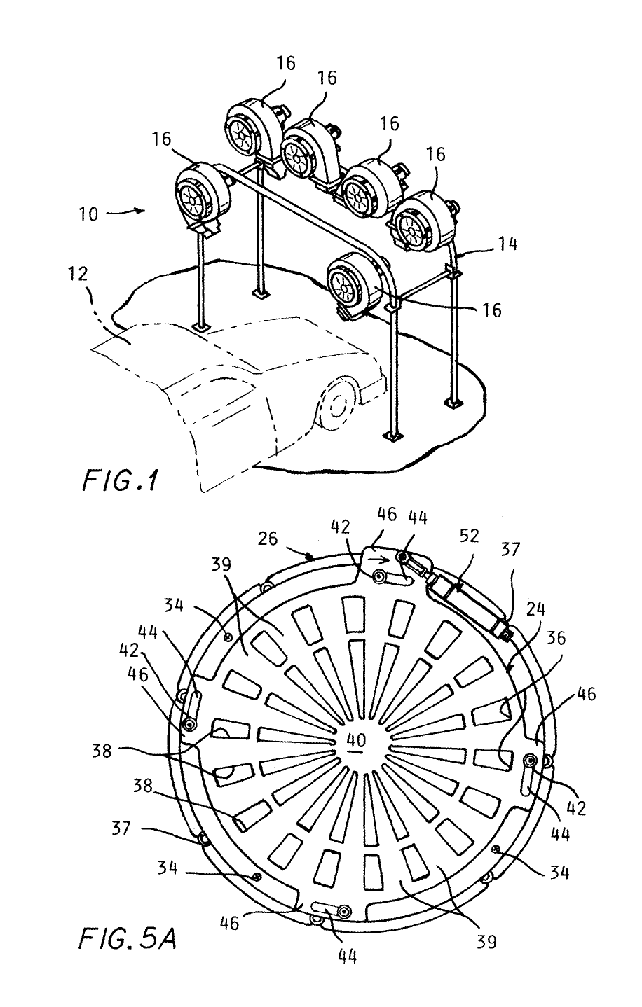

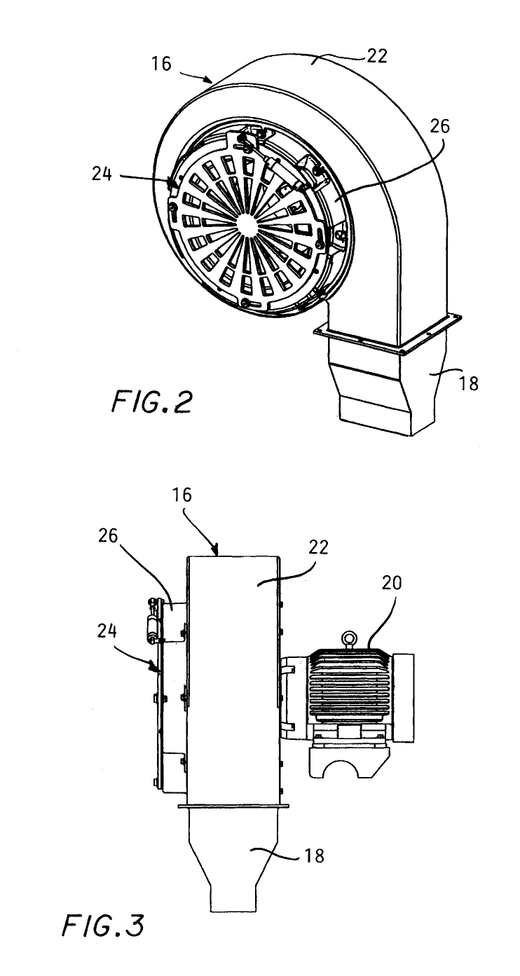

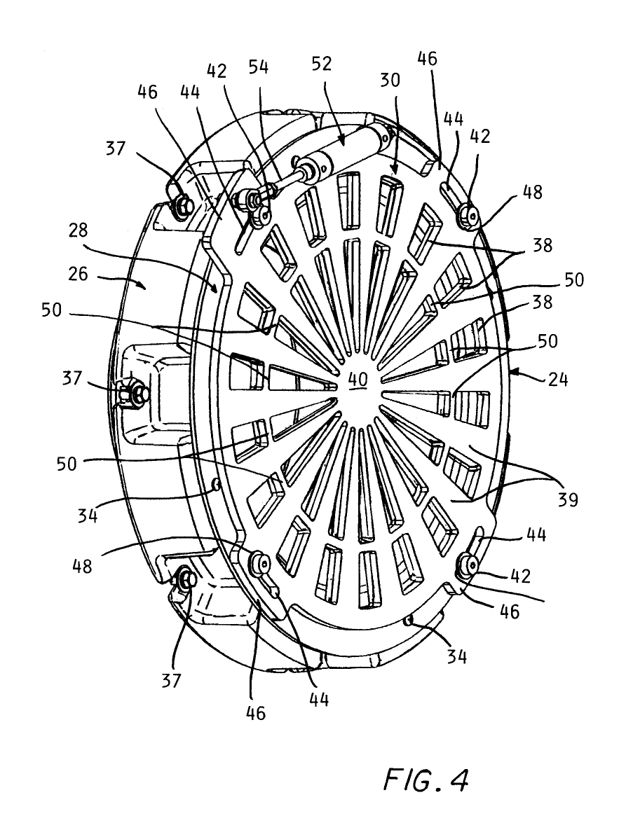

Referring to the drawings, FIG. 1 shows the dryer zone 10 of a typical car wash system. A car 12 depicted in fragmentary form is transported into the zone by a conveyor engaging the vehicle tires in the well known manner.

A framework 14 through which the car can pass has an overhead array of high volume blowers 16 mounted thereon. The blowers or fans are typically of a centrifugal design with well know squirrel cage impeller. Each blower 16 has a nozzle outlet 18 directing a powerful stream of air at the washed vehicle to blow off rinse water and dry the car, also in the well known manner.

Such air blowers 16 are powered by electric motors 20 (FIG. 3) driving an internal impeller rotor (not shown) within a blower housing 22 to generate the air flow exiting the nozzle outlet 18.

The air is drawn in through an inlet opening 32 (FIG. 6) defined by an inlet flow guide 26 centered on one side of the blower housing 22.

According to the present invention, a controllably openable and closable flow restrictor arrangement 24 is mounted to an inlet flow guide 26 attached to the blower housing 22 on the inlet side by screws 27.

The flow restrictor 74 is comprised of two discs 28, 30 stacked together over the blower air inlet 32 and secured to the inlet collar 26 with a series of screws 34 received through the inner round plate 28.

The inner and outer discs 28, 30 are each formed with a set of short radially extending slots 38 which are matched to each other. The slots 38 are tapered in shape, of a minimum width at a central hub 40 and tapering out to a maximum width and the outer region of each disc 28, 30. A series of similarly sized and shaped spokes 36 are provided on each disc 28,30 located intermediate the radially extending slots 38 so that an alternating pattern of radial slots and spokes is created.

The radially slots extending 38 may have intermediate bridging portions 40 integral with the adjacent spokes 39 to strengthen and stiffen the outer disc 30 in the region of the slots 38.

The discs 28, 30 are preferably made of a tough plastic such as PVC so as to be slidable over each other even when pressed tightly together by the vacuum developed in the housing 18 when the spokes 39 in the outer disc 30 overlies the slots 38 in the inner disc 30.

The outer disc 30 is held against the inner disc 28 by a series of four cap screws 42 each passing through one of short arcuate slot 44 formed into ears 46 projecting from the perimeter of the outer discs 30.

Pairs of washers 48 are also provided on each cap screw 42 which insure smooth sliding along the slots 44 when the outer disc 30 is rotated relative the inner plate 28 a short distance allowed by the length of the short slots 44.

Such motion is produced by a double acting short stroke power cylinder 52 mounted at one end to the inlet flow guide 26.

An output rod 54 of the power cylinder 52 has an end pivotally mounted to a bolt 56 secured to one of the ears 46 on the outer plate 30.

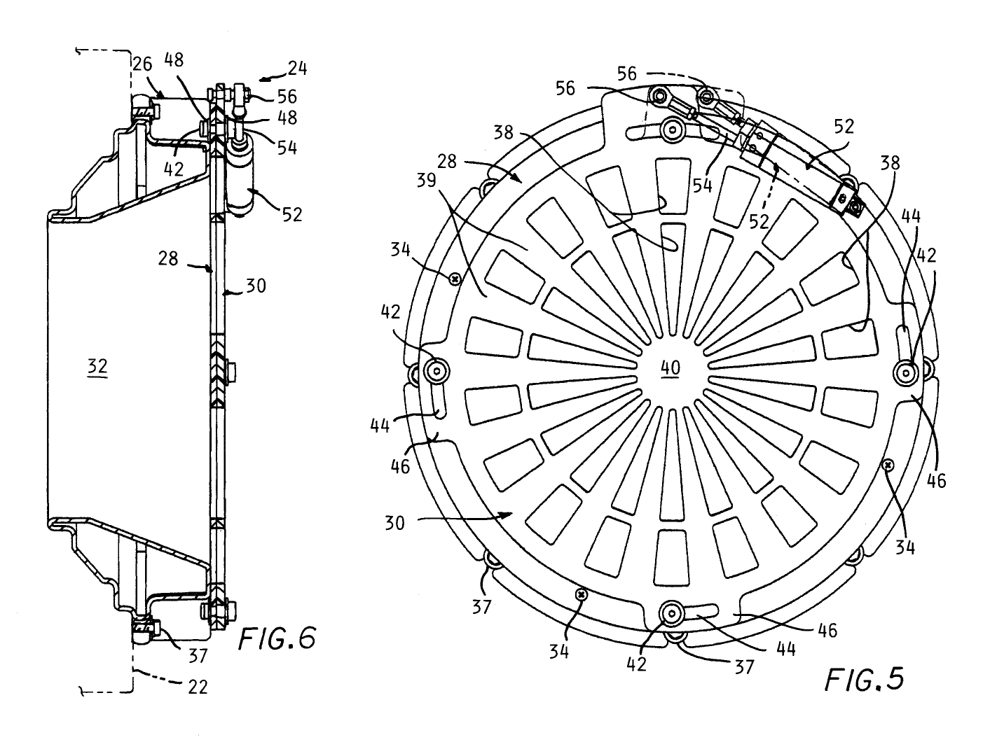

In the open position of the two discs 28, 30 shown in FIG. 5, the two sets of slots 38 are aligned with each other and air can freely pass into the inlet 32 when a car is present in the zone to be dried.

When no car is present in the drying zone, the system controls operate the power cylinder 52 to position the two plates 28, 30 in a rotated state with the slots 38 in the inner disc 28 covered by the spokes 39 in the outer disc 30 to close the openings defined by the slots 20 block air flow into the inlet 32 as shown in FIG. 5.

This has the effect of greatly reducing the load on the motor 28 since the air flow is greatly reduced and the resultant noise of the air flow since the blowers 16 will not be discharging a significant volume of air.

The spokes 39 on the discs 28, 30 also act as a safety barrier preventing the entry of large objects or a person's hand to provide a safety barrier.

Thus, a compact, simple flow restrictor arrangement is provided for reducing the air flow when not needed, which does not significantly reduce air flow when in the open state.

The minimal extent of rotation (the width of one slot) required to open or close the flow restrictor speeds the opening or closing and minimizes the power required.

1. An inlet air flow restrictor arrangement combined with each air blower in a car wash system drying zone;
said blowers each including a housing and an air inlet opening on one side thereof;
said arrangement including two discs mounted on said blower housing covering said inlet opening;
each disc having a set of radially extending slots matched to each other with an intermediate spoke lying between each adjacent pair of slots, said discs relatively rotatable between an open position whereat said slots are aligned to allow entry of air into said inlet and a position whereat said radially extending set of slots in one disc are misaligned and covered by the spokes in the other disc so as to block entry of air into said air inlet opening; and, a system controlled actuator powering said plates to be rotated relative each other between said open and closed positions to open or close off said air inlet opening.

2. The combination according to claim 1 wherein one of said discs has one or more circumferential slots formed thereon receiving a fastener installed on the other disc, said fastener limiting relative rotation of said two discs by abutting each end of said slot to thereby relatively position said discs corresponding to each of said open and closed position.

3. The combination according to claim 1 wherein said radially extending slots and spokes are of a tapering shape increasing in width from a point close to a center of said discs to points radially outward thereform.

4. The combination according to claim 2 wherein said actuator comprises a power cylinder mounted to said blower housing having an output rod pivotally attached to said outer disc to enable powered relatively minimal rotary motion between said discs when said power cylinder is activated to move said output rod.

5. The combination of claim 1 wherein said radially extending slots and spokes are matched to each other in size and shape.

6. In a car wash system, a method of restricting the air flow into an inlet opening in a centrifugal blower housing used to dry a car washed in said system comprising covering the air inlet with two stacked together discs, each formed with sets of matched radially extending alternating slots and spokes; relatively rotating said discs between a position where said sets of slots are aligned to allow flow and a position whereat said set of slots in one disc are covered by said set of spokes in another position to restrict air flow into said inlet opening.
